(19) United States
(12) Patent Application Publication
(10) Pub. No.: US 2022/0112088 A1
(43) Pub. Date: Apr. 14, 2022

(54) PLATE-LIKE ALUMINA PARTICLES, METHOD FOR PRODUCING PLATE-LIKE ALUMINA PARTICLES, AND RESIN COMPOSITION

(71) Applicant: DIC Corporation, Tokyo (JP)

(72) Inventors: Shingo Takada, Sakura-shi (JP); Ryuu Koike, Sakura-shi (JP); Jianjun Yuan, Sakura-shi (JP); Yoshiyuki Sano, Sakura-shi (JP)

(73) Assignee: DIC Corporation, Tokyo (JP)

(21) Appl. No.: 17/312,677

(22) PCT Filed: Dec. 20, 2019
(86) PCT No.: PCT/JP2019/050077

§ 371 Date: Jun. 10, 2021

(30) Foreign Application Priority Data
Dec. 28, 2018 (JP) 2018-247894

(51) Int. Cl. C01F 7/442; C08K 7/00; C08K 3/22; C08L 101/00

(52) U.S. Cl. CPC C01F 7/442; C08K 7/00; C08K 3/22; C08L 101/00; C08K 2003/2227; C01P 2004/61; C01P 2004/62; C01P 2004/90; C01P 2004/20; C01P 2002/86

(57) ABSTRACT

Plate-like alumina particles have an aspect ratio of 5 to 500, in which in solid-state ²⁷Al NMR analysis, the longitudinal relaxation time T₁ for a peak of six-coordinated aluminum at 10 to 30 ppm is 5 seconds or more at a static magnetic field strength of 14.1 T.

### TECHNICAL FIELD

The present invention relates to plate-like alumina particles, a method for producing plate-like alumina particles, and a resin composition.

This application claims the benefit of Japanese Patent Application No. 2018-247894 filed Dec. 28, 2018, which is hereby incorporated by reference herein in its entirety.

### BACKGROUND ART

Alumina particles, serving as inorganic fillers, are used in various applications. In particular, plate-like alumina particles having high aspect ratios are particularly excellent in thermal and optical properties and so forth, compared with spherical alumina particles, and required to have further improved performance.

Hitherto, various types of plate-like alumina particles having shape characteristics, such as long-axis diameter and thickness, for improving the above-mentioned properties and dispersibility inherent in plate-like alumina particles have been known (PTLs 1 and 2). Known examples of a method for producing plate-like alumina particles having a controlled shape so as to have a high aspect ratio include a method in which hydrothermal synthesis is performed with a phosphate compound added as a shape-controlling agent (PTL 3); and a method in which firing is performed with a silicofluoride added (PTL 4).

Regarding the production of plate-like alumina, a method for producing plate-like alumina with silicon or a silicon element-containing silicon compound as a crystal control agent is also known (PTL 5).

### CITATION LIST

### Patent Literature

PTL 1: Japanese Unexamined Patent Application Publication No. 2003-192338
PTL 2: Japanese Unexamined Patent Application Publication No. 2002-249315
PTL 3: Japanese Unexamined Patent Application Publication No. 9-59018
PTL 4: Japanese Unexamined Patent Application Publication No. 2009-35430
PTL 5: Japanese Unexamined Patent Application Publication No. 2016-222501

### SUMMARY OF INVENTION

### Technical Problem

Plate-like alumina particles in the related art, however, have a problem that when these particles are mixed with a resin to prepare a resin composition, a difficulty lies in processing the resin composition into a desired shape because of its poor processing stability.

The present invention has been made in order to solve the problems as described above. It is an object of the present invention to provide alumina particles in which when the alumina particles are mixed with a resin to prepare a resin composition, the resin composition has excellent processing stability.

It is another object of the present invention to provide a resin composition having excellent processing stability.

### Solution to Problem

The inventors have conducted intensive studies in order to solve the above-mentioned problems and have found that plate-like alumina particles having a plate shape and excellent crystallinity can be produced and a resin composition containing the plate-like alumina particles has excellent processing stability. These findings have led to the completion of the present invention.

That is, embodiments of the present invention provide plate-like alumina particles, a method for producing plate-like alumina particles, and a resin composition described below.

(1) Plate-like alumina particles have an aspect ratio of 5 to 500, in which

In solid-state ²⁷Al NMR analysis, a longitudinal relaxation time T₁ for a peak of six-coordinated aluminum at 10 to 30 ppm is 5 seconds or more at a static magnetic field strength of 14.1 T.

(2) The plate-like alumina particles described in (1) contain silicon and/or germanium.
(3) The plate-like alumina particles described in (1) or (2) contain molybdenum.
(4) In the plate-like alumina particles described in (3), the plate-like alumina particles have a molybdenum content of 0.1% or more and 1% or less by mass in terms of molybdenum trioxide based on 100% by mass of the total mass of the plate-like alumina particles.
(5) In the plate-like alumina particles described in (1) to (4), the plate-like alumina particles have a thickness of 0.01 to 5 μm and an average particle size of 0.1 to 500 μm.
(6) In the plate-like alumina particles described in (1) to (5), the plate-like alumina particles have an average particle size of 0.1 to 7 μm.
(7) A method for producing plate-like alumina particles described in (1) to (6) includes mixing an aluminum element-containing aluminum compound, a molybdenum element-containing molybdenum compound, and a shape-controlling agent together to prepare a mixture, and firing the mixture at 1,200° C. or higher.
(8) In the method for producing plate-like alumina particles described in (7), the shape-controlling agent is at least one selected from the group consisting of silicon, silicon compounds, and germanium compounds.
(9) In the method for producing plate-like alumina particles described in (7) or (8), 50% or more by mass of the aluminum element-containing aluminum compound in terms of Al₂O₃, 2% or more by mass and 15% or less by mass of the molybdenum element-containing molybdenum compound in terms of MoO₃, and 0.1% or more by mass and 10% or less by mass of the shape-controlling agent in terms of SiO₂ or GeO₂ based on 100% by mass of the total amount of the raw materials on an oxide basis are mixed together to prepare a mixture, and the mixture is fired.
(10) A resin composition contains a resin and the plate-like alumina particles described in any one of (1) to (6).

### Advantageous Effects of Invention

According to the present invention, it is possible to provide plate-like alumina particles in which when the plate-like alumina particles are mixed with a resin to prepare a resin composition, the resin composition has excellent processing stability.

According to the present invention, moreover, a resin composition having excellent processing stability can be provided.

### DESCRIPTION OF EMBODIMENTS

Plate-like alumina particles, a method for producing plate-like alumina particles, and resin composition according to embodiments of the present invention will be described below.

### <<Plate-Like Alumina Particles>>

Plate-like alumina particles according to an embodiment have an aspect ratio of 5 to 500, in which in solid-state ²⁷Al nuclear magnetic resonance (NMR) spectroscopy, the longitudinal relaxation time T₁ for a peak of six-coordinated aluminum observed at 10 to 30 ppm is 5 seconds or more at a static magnetic field strength of 14.1 T.

In the plate-like alumina particles according to the embodiment, the longitudinal relaxation time T₁ is 5 seconds or more. This indicates that the plate-like alumina particles have high crystallinity. The findings in which a long longitudinal relaxation time in a solid state indicates good crystal symmetry and high crystallinity have been reported (previous report: Susumu Kitagawa et al., “Sakutai Kagaku kai Sensho 4 Takakushu no Yoeki Oyobi Kotai NMR (Japan Society of Coordination Chemistry Selection 4 Multinuclear Solution and Solid-State NMR)”, Sankyo Shuppan Co., Ltd., p. 80-82)).

In the plate-like alumina particles according to the embodiment, the longitudinal relaxation time T₁ is 5 seconds or more, preferably 5 seconds or more, more preferably 6 seconds or more, more preferably 7 seconds or more.

In the plate-like alumina particles according to the embodiment, the upper limit of the longitudinal relaxation time T₁ is not particularly limited and, for example, may be 22 seconds or less, 15 seconds or less, or 12 seconds or less.

Examples of the numerical range of the longitudinal relaxation time T₁ exemplified above may include 5 seconds or more and 22 seconds or less, 6 seconds or more and 15 seconds or less, and 7 seconds or more and 12 seconds or less.

In the plate-like alumina particles according to the embodiment, preferably, the peak of four-coordinated aluminum at 60 to 90 ppm in solid-state ²⁷Al NMR analysis is not detected at a static magnetic field strength of 14.1 T. Such plate-like alumina particles tend to have higher shape stability.

Hitherto, the degree of the crystallinity of an inorganic substance has been typically evaluated by the results of X-ray diffraction (XRD) analysis. However, studies by the inventors have indicated that the use of the above-mentioned longitudinal relaxation time T₁ as an index for the evaluation of the crystallinity of the alumina particles provides more accurate analysis results than conventional XRD analysis. Moreover, it has been found that the value of the longitudinal relaxation time T₁ correlates very well with the shape retention rate of the plate-like alumina particles (see Examples described below) and the processing stability of the resin composition. In the plate-like alumina particles according to the embodiment, the longitudinal relaxation time T₁ is as long as 5 seconds or more, thus indicating that the alumina particles have high crystallinity. That is, the plate-like alumina particles according to the embodiment have high strength presumably due to their high crystallinity. This seems to result in an improved shape retention rate and excellent processing stability of the resin composition.

Hitherto, it has been difficult to produce plate-like alumina particles having high crystallinity, compared with spherical alumina particles. This is thought to be due to the fact that, unlike spherical alumina particles, plate-like alumina particles need to be biased in the direction of crystal growth during the production process.

In contrast, the plate-like alumina particles according to the embodiment have high crystallinity despite their plate-like shape. Thus, they are very useful because they have the advantages of plate-like alumina particles, which have excellent thermal conductivity and so forth, and also have an improved shape retention rate and improved processing stability of the resin composition.

The term “plate-like” used in this specification indicates that the aspect ratio obtained by dividing the average particle size of the alumina particles by the thickness thereof is 2 or more. However, a higher aspect ratio makes it difficult to produce particles having high crystallinity. From the viewpoint of achieving both of them, the alumina particles according to the embodiment have an aspect ratio of 5 or more. In this specification, the term “thickness of alumina particles” refers to arithmetic mean value of the thicknesses measured for at least 50 plate-like alumina particles randomly selected from images captured with a scanning electron microscope (SEM). The term “average particle size of alumina particles” refers to a value calculated as a median diameter d50 on a volume basis from a cumulative particle size distribution on a volume basis measured with a laser diffraction/scattering particle size distribution analyzer.

The values of the thickness, the average particle size, and the aspect ratio of the alumina particles according to the embodiment can be freely combined as long as they have a plate-like shape.

Preferably, the plate-like alumina particles according to the embodiment have a thickness of 0.01 to 5 μm, an average particle size of 0.1 to 500 μm, and an aspect ratio, which is the ratio of the particle size to the thickness, of 5 to 500. The plate-like alumina particles having an aspect ratio of 5 or more can have two-dimensional alignment characteristics and thus are preferred. The plate-like alumina particles having an aspect ratio of 500 or less have excellent mechanical strength and thus are preferred. More preferably, the plate-like alumina particles according to the embodiment have a thickness of 0.03 to 3 μm, an average particle size of 0.5 to 100 μm, and an aspect ratio, which is the ratio of the particle size to the thickness, of 10 to 300. An aspect ratio of 10 to 300 is preferred because when the plate-like alumina particles are used in a pigment, high brightness is obtained. Even more preferably, the plate-like alumina particles according to the embodiment have a thickness of 0.1 to 1 μm, an average particle size of 1 to 50 μm, and an aspect ratio, which is the ratio of the particle size to the thickness, of 11 to 100.

From the point of view that it is more difficult to produce highly crystalline plate-like alumina particles as the average particle size of the particles decreases, the plate-like alumina particles according to the embodiment preferably have an average particle size of 0.1 to 7 μm, more preferably 0.1 to 5 μm. Similarly, from the point of view that it is more difficult to produce highly crystalline plate-like alumina particles as the aspect ratio of the particles increases, the plate-like alumina particles according to the embodiment preferably have an aspect ratio of 17 to 50.

The plate-like alumina particles according to the embodiment may have a circular plate-like shape or an elliptical plate-like shape. Preferred examples of the shape of the particles include polygonal plate-like shapes, such as hexagonal to octagonal shapes, in view of handleability and ease of production.

For example, the thickness, the average particle size, and the aspect ratio of the plate-like alumina particles according to the embodiment can be controlled, for example, by appropriately selecting the proportions of a molybdenum compound, an aluminum compound, and a shape-controlling agent used, the type of shape-controlling agent, and the states of the shape-controlling agent and the aluminum compound present.

The plate-like alumina particles may contain molybdenum. The plate-like alumina particles may contain impurities from the raw materials, the shape-controlling agent, and so forth. The plate-like alumina particles may further contain, for example, an organic compound.

In the plate-like alumina particles, the physical properties and performance, such as optical properties, for example, hue and transparency, of the plate-like alumina in accordance with intended use can be freely adjusted by adding molybdenum thereto and controlling the amount of molybdenum contained and the state of molybdenum present in a production method described below.

The plate-like alumina particles according to the embodiment may be produced by any production method as long as the aspect ratio is 5 to 500 and the longitudinal relaxation time T₁ is 5 seconds or more. Preferably, the plate-like alumina particles are produced by firing the aluminum compound in the presence of the molybdenum compound and the shape-controlling agent from the viewpoint of achieving a higher aspect ratio, better dispersibility, and better productivity. As the shape-controlling agent, at least one selected from the group consisting of silicon, silicon compounds, and germanium compounds is preferably used.

In the production method, the molybdenum compound is used as a flux agent. In this specification, hereinafter, this production method using the molybdenum compound as a flux agent is simply referred to as a “flux method”, in some cases. The flux method will be described in detail below. When the molybdenum compound reacts with the aluminum compound at a high temperature into aluminum molybdate during the firing and then the aluminum molybdate decomposes at a higher temperature into alumina and molybdenum oxide, the molybdenum compound is seemingly incorporated into the plate-like alumina particles. The molybdenum oxide can be recovered by sublimation and then reused.

The molybdenum oxide that is not incorporated into the plate-like alumina particles is preferably recovered by sublimation and then reused. This enables a reduction in the amount of molybdenum oxide adhering to surfaces of the plate-like alumina. When the plate-like alumina particles are dispersed in an organic binder, such as a resin, or an inorganic binder, such as glass, the molybdenum oxide does not mix with the binder; thus, the original properties of the plate-like alumina can be maximized.

In this specification, a substance that can sublimate in the production method described below is referred to as a “flux agent”, and a substance that cannot sublimate is referred to as a “shape-controlling agent”.

In the production of the plate-like alumina particles, the use of molybdenum and the shape-controlling agent results in alumina particles having a high degree of α-crystallization and euhedral forms; thus, the alumina particles can have excellent dispersibility, excellent mechanical strength, and high thermal conductivity.

The pH of the plate-like alumina particles according to the embodiment at the isoelectric point is in the range of, for example, 2 to 6, preferably 2.5 to 5, more preferably 3 to 4. The plate-like alumina particles having a pH within the above range at the isoelectric point have high electrostatic repulsion and can have high dispersion stability itself when mixed with a dispersion medium as described above. This facilitates modification by surface treatment with, for example, a coupling treatment agent in order to further improve the performance.

The pH value at the isoelectric point is obtained by zeta potential measurement with a zeta potential measurement system (Zetasizer Nano ZSP, available from Malvern Panalytical Ltd.) as described below: 20 mg of a sample and 10 mL of an aqueous solution of 10 mM KCl are stirred with a Awatori Rentaro Thinky Mixer (ARE-310, available from Thinky Corporation) in mixing-deaeration mode for 3 minutes. The supernatant is allowed to stand for 5 minutes and used as a measurement sample. Then 0.1 N HCl is added to the sample with an automatic titrator, and the zeta potential is measured up to pH=2 (applied voltage: 100 V, Monomodl mode). The pH at the isoelectric point where the potential is zero is evaluated.

The plate-like alumina particles according to the embodiment have a density of, for example, 3.70 g/cm³ or more and 4.10 g/cm³ or less, preferably 3.72 g/cm³ or more and 4.10 g/cm³ or less, more preferably 3.80 g/cm³ or more and 4.10 g/cm³ or less.

The plate-like alumina particles are pretreated at 300° C. for 3 hours, and then the density can be measured with an AccuPyc II 1330 dry-process automated pycnometer, available from Micromeritics Instrument Corporation, at a measurement temperature of 25° C. using helium as a carrier gas.

### [Alumina]

The “alumina” contained in the plate-like alumina particles according to the embodiment is aluminum oxide. Transition aluminas in various crystalline phases, such as γ, δ, θ, and κ, may be used. A transition alumina containing hydrated alumina may also be used. The α-crystalline phase (α-phase) is basically preferred in terms of better mechanical strength or better thermal conductivity. The α-crystalline phase is a dense crystal structure of alumina and is advantageous for improving the mechanical strength or thermal conductivity of the plate-like alumina according to the embodiment.

The degree of α crystallization is preferably as close to 100% as possible because the original properties of the α-crystalline phase are easily provided. The plate-like alumina particles according to the embodiment have a degree of α crystallization of, for example, 90% or more, preferably 95% or more, more preferably 99% or more.

### [Silicon and Germanium]

The plate-like alumina particles according to the embodiment may contain silicon and/or germanium.

In the case where silicon or a silicon compound is used as a shape-controlling agent for the plate-like alumina particles according to the embodiment, Si can be detected by X-ray fluorescence (XRF) analysis. In the plate-like alumina particles according to the embodiment, the ratio by mole of Si to Al, i.e., [Si]/[Al], obtained by the XRF analysis is, for example, 0.04 or less, preferably 0.035 or less, more preferably 0.02 or less.

The value of the [Si]/[Al] ratio by mole is, but not particularly limited to, for example, 0.003 or more, preferably 0.004 or more, more preferably 0.008 or more.

In the plate-like alumina particles according to the embodiment, the ratio by mole of Si to Al, i.e., [Si]/[Al], obtained by the XRF analysis is, for example, 0.003 or more and 0.04 or less, preferably 0.004 or more and 0.035 or less, more preferably 0.008 or more and 0.02 or less.

The plate-like alumina particles in which the value of the [Si]/[Al] ratio by mole obtained by the XRF analysis is within the above range have a high aspect ratio, and a more preferred value of the longitudinal relaxation time T₁ (high crystallinity) is obtained.

The plate-like alumina particles according to the embodiment can contain silicon originating from silicon or a silicon compound used in the production method. The silicon content is, in terms of silicon dioxide, preferably 10% or less by mass, more preferably 0.001% to 5% by mass, more preferably 0.01% to 4% by mass, particularly preferably 0.6% to 2.5% by mass based on 100% by mass of the plate-like alumina particles according to the embodiment (100% by mass of the total mass of the plate-like alumina particles). When the silicon content is within the above range, a high aspect ratio and a more preferred value of the longitudinal relaxation time T₁ (high crystallinity) are obtained, which are preferred. The silicon content can be determined by the XRF analysis.

In the plate-like alumina particles according to the embodiment, in the case where germanium or a germanium compound is used as a shape-controlling agent, Ge can be detected by the XRF analysis. In the plate-like alumina particles according to the embodiment, the ratio by mole of Ge to Al, i.e., [Ge]/[Al], obtained by the XRF analysis is, for example, 0.08 or less, preferably 0.05 or less, more preferably 0.03 or less.

The value of the [Ge]/[Al] ratio by mole is, but not particularly limited to, for example, 0.005 or more, preferably 0.01 or more, more preferably 0.015 or more.

The value of the [Ge]/[Al] ratio by mole is, but not particularly limited to, for example, 0.0005 or more, preferably 0.001 or more, more preferably 0.0015 or more.

In the plate-like alumina particles according to the embodiment, the ratio by mole of Ge to Al, i.e., [Ge]/[Al], obtained by the XRF analysis is, for example, 0.005 or more and 0.08 or less, preferably 0.01 or more and 0.05 or less, more preferably 0.015 or more and 0.03 or less.

In the plate-like alumina particles according to the embodiment, the ratio by mole of Ge to Al, i.e., [Ge]/[Al], obtained by the XRF analysis is, for example, 0.0005 or more and 0.08 or less, preferably 0.001 or more and 0.05 or less, more preferably 0.0015 or more and 0.03 or less.

The plate-like alumina particles in which the value of the [Ge]/[Al] ratio by mole obtained by the XRF analysis is within the above range have a high aspect ratio, and a more preferred value of the longitudinal relaxation time T₁ (high crystallinity) is obtained.

The plate-like alumina particles according to the embodiment can contain germanium originating from the germanium compound serving as a raw material used in the production method. The germanium content is, in terms of germanium dioxide, preferably 10% or less by mass, more preferably 0.001% to 5% by mass, even more preferably 0.01% to 4% by mass, still even more preferably 0.1% to 3.0% by mass, particularly preferably 0.6% to 3.0% by mass based on 100% by mass of the plate-like alumina particles according to the embodiment (100% by mass of the total mass of the plate-like alumina particles). When the germanium content is within the above range, a high aspect ratio and a more preferred value of the longitudinal relaxation time T₁ (high crystallinity) are obtained. The germanium content can be determined by the XRF analysis.

### [Molybdenum]

The plate-like alumina particles according to the embodiment may contain molybdenum. The molybdenum originates from the molybdenum compound used as a flux agent.

Molybdenum has catalytic and optical functions. The use of molybdenum makes it possible to produce the plate-like alumina particles having a high aspect ratio and excellent dispersibility. Additionally, the plate-like alumina particles can be used for applications, such as oxidation reaction catalysts and optical materials, by the use of the properties of molybdenum contained in the plate-like alumina particles.

Examples of the molybdenum include, but are not particularly limited to, molybdenum metal, molybdenum oxides, and partially reduced molybdenum compounds. Molybdenum seems to be contained in the plate-like alumina particles in the form of MoO₃ and may be contained in the form of, for example, MoO₂ or MoO, in addition to MoO₃.

Molybdenum may be contained in any form, may be contained in the form in which molybdenum adheres to the surfaces of the plate-like alumina particles, may be contained in the form in which aluminum atoms in the crystal structure of alumina are partially replaced with molybdenum, or may be contained in a combination of these forms.

The molybdenum content is, in terms of molybdenum trioxide, preferably 10% or less by mass, more preferably 5% or less by mass, even more preferably 2% or less by mass, particularly preferably 1% or less by mass based on 100% by mass of the plate-like alumina particles according to the embodiment (100% by mass of the total mass of the plate-like alumina particles).

The molybdenum content is, in terms of molybdenum trioxide, preferably 0.001% or more by mass, more preferably 0.01% or more by mass, even more preferably 0.1% or more by mass based on 100% by mass of the plate-like alumina particles according to the embodiment.

As an example of the numerical range of the above values, the molybdenum content based on 100% by mass of the plate-like alumina particles according to the embodiment may be, in terms of molybdenum trioxide, in the range of 0.001% to 5% by mass, 0.01% to 2% by mass, or 0.1% to 1% by mass. A molybdenum content of 10% or less by mass results in an improvement in the α-single crystalline quality of alumina and thus is preferred.

The molybdenum content can be determined by XRF analysis. The XRF analysis is performed under the same conditions as the measurement conditions described in Examples or under compatible conditions that give identical measurement results.

### [Organic Compound]

In an embodiment, the plate-like alumina particles may contain an organic compound. The organic compound is present on the surfaces of the plate-like alumina particles and has the function of adjusting the surface properties of the plate-like alumina particles. For example, the plate-like alumina particles having an organic compound on the surfaces thereof have an improved affinity for a resin. Thus, the function of the plate-like alumina particles as fillers can be maximized.

Examples of the organic compound include, but are not particularly limited to, organic silanes, alkylphosphonic acids, and polymers.

Examples of the organic silane compound include methyltrimethoxysilane, dimethyldimethoxysilane, ethyltrimethoxysilane, ethyltriethoxysilane, n-propyltrimethoxysilane, n-propyltriethoxysilane, alkyltrimethoxysilanes whose alkyl groups each have 1 to 22 carbon atoms, such as isopropyltrimethoxysilane, isopropyltriethoxysilane, pentyltrimethoxysilane, hexyltrimethoxysilane, and octenyltrimethoxysilane, alkyltrichlorosilanes, 3,3,3-trifluoropropyltrimethoxysilane, tridecafluoro-1,1,2,2-tetrahydrooctyl)trichlorosilane, phenyltrimethoxysilane, phenyltriethoxysilane, p-chloromethylphenyltrimethoxysilane, p-chloromethylphenyltriethoxysilane, epoxysilanes, such as γ-glycidoxypropyltrimethoxysilane, γ-glycidoxypropyltriethoxysilane, β-(3,4-epoxycyclohexyl)ethyltrimethoxysilane, and glycidoxyoctyltrimethoxysilane, aminosilanes, such as γ-aminopropyltriethoxysilane, N-β(aminoethyl)γ-aminopropyltrimethoxysilane, N-β(aminoethyl)γ-aminopropylmethyldimethoxysilane, γ-aminopropyltrimethoxysilane, and γ-ureidopropyltriethoxysilane, mercaptosilanes, such as 3-mercaptopropyltrimethoxysilane, vinylsilanes, such as p-styryltrimethoxysilane, vinyltrichlorosilane, vinyltris(β-methoxyethoxy)silane, vinyltrimethoxysilane, vinyltriethoxysilane, γ-methacryloxypropyltrimethoxysilane, and methacryloxyoctyltrimethoxysilane, and epoxy-, amino-, and vinyl-based polymeric silanes. The above-mentioned organic silane compounds may be contained alone or in combination of two or more.

Examples of the phosphonic acid include methylphosphonic acid, ethylphosphonic acid, pxopylphosphonic acid, butylphosphonic acid, pentylphosphonic acid, hexylphosphonic acid, heptylphosphonic acid, octylphosphonic acid, decylphosphonic acid, dodecylphosphonic acid, octadecylphosphonic acid, 2-ethylhexylphosphonic acid, cyclohexylmethylphosphonic acid, cyclohexylethylphosphonic acid, benzylphosphonic acid, phenylphosphonic acid, and dodecylbenzenephosphonic acid.

As the polymer, for example, poly(meth)acrylates can be suitably used. Specific examples thereof include poly(methyl(meth)acrylate), poly(ethyl (meth)acrylate), poly(butyl (meth)acrylate), poly(benzyl (meth)acrylate), poly(cyclohexyl (meth)acrylate), poly(tert-butyl (meth)acrylate), poly(glycidyl (meth)acrylate), and poly(pentafluoropropyl (meth)acrylate). Further examples thereof include general-purpose polymers, such as polystyrene, poly(vinyl chloride), poly(vinyl acetate), epoxy resins, polyesters, polyimides, and polycarbonates.

The above-mentioned organic compounds may be contained alone or in combination of two or more.

The organic compound may be contained in any form. The organic compound may be linked to alumina by covalent bonds or may cover alumina.

The organic compound content is preferably 20% or less by mass, more preferably 10% to 0.01% by mass based on the total mass of the plate-like alumina particles. An organic compound content of 20% or less by mass is preferred because the physical properties originating from the plate-like alumina particles can be easily provided.

In the case where the plate-like alumina particles according to the embodiment are mixed with a resin to prepare a resin composition, the resin composition has good processing stability and thus is easily processed into a desired shape. In the plate-like alumina particles according to the embodiment, the long longitudinal relaxation time T₁ is long, and high crystallinity is obtained. Accordingly, the plate-like alumina particles according to the embodiment have high particle strength because of the high crystallinity of the alumina. When the plate-like alumina particles are mixed with the resin during the production process of the resin composition, the plates seem to be not easily broken. Moreover, the plate-like alumina particles according to the embodiment seem to have excellent adhesion to the resin presumably because of a low surface roughness of each particle due to the high crystallinity of the alumina. These factors seem to bring about good processing stability of the resin composition containing the plate-like alumina particles according to the embodiment. For example, even in the case of mixing the plate-like alumina particles according to the embodiment with a resin composition, the original performance of the plate-like alumina particles is satisfactorily exhibited.

### <Method for Producing Plate-Like Alumina Particles>

A method for producing plate-like alumina particles is not particularly limited, and a known technique can be appropriately used. From the viewpoint of appropriately controlling alumina having a high degree of n crystallization at a relatively low temperature, a production method by a flux method with a molybdenum compound can be preferably employed.

Specifically, a preferred method for producing plate-like alumina particles includes a step of firing an aluminum compound in the presence of the molybdenum compound and a shape-controlling agent (firing step). The firing step may be a step of firing a mixture prepared in a step of preparing the mixture to be fired (mixing step).

### [Mixing Step]

The mixing step is a step of mixing an aluminum compound, the molybdenum compound, and the shape-controlling agent together to prepare a mixture. The contents of the mixture will be described below.

### (Aluminum Compound)

The aluminum compound in this specification is not particularly limited as long as it contains aluminum element, is a raw material for the plate-like alumina particles according to the embodiment, and is formed into alumina by heat treatment. Examples of the aluminum compound that can be used include aluminum chloride, aluminum sulfate, basic aluminum acetate, aluminum hydroxide, boehmite, pseudoboehmite, transition aluminas (such as γ-alumina, δ-alumina, and θ-alumina), α-alumina, and mixed alumina having two or more crystalline phases. The physical forms, such as the shape, particle size, and specific surface area, of the aluminum compound serving as a precursor is not particularly limited.

According to the flux method described in detail below, as the shape of the plate-like alumina particles according to the embodiment, any of shapes, such as spherical shapes, indefinite shapes, high-aspect-ratio structures (for example, wires, fibers, ribbons, and tubes), and sheets can be suitably used.

Similarly, regarding the particle size of the aluminum compound, according to the flux method described in detail below, the solid of the aluminum compound having a particle size of several nanometers to several hundred micrometers can be suitably used.

The specific surface area of the aluminum compound is not particularly limited. A large specific surface area is preferred because the molybdenum compound acts effectively. However, the aluminum compound having any specific surface area can be used as a raw material by adjusting the firing conditions and the amount of molybdenum compound used.

The aluminum compound may be composed of only an aluminum compound or a composite of an aluminum compound and an organic compound. For example, an organic-inorganic composite formed by modifying an aluminum compound with an organic silane or an aluminum compound composite on which a polymer is adsorbed can be suitably used. In the case of using any of these composites, the organic compound content is not particularly limited. From the viewpoint of efficiently producing the plate-like alumina particles, the organic compound content is preferably 60% or less by mass, more preferably 30% or less by mass based on the total mass of the aluminum compound.

### (Shape-Controlling Agent)

To form the plate-like alumina particles according to the embodiment, a shape-controlling agent can be used.

The shape-controlling agent plays an important role in the growth of the plate crystals of alumina by firing an alumina compound in the presence of a molybdenum compound.

The state of the shape-controlling agent present is not particularly limited. For example, a physical mixture of the shape-controlling agent and the aluminum compound or a composite in which the shape-controlling agent is present uniformly or locally on the surface of or inside the aluminum compound can be suitably used.

The shape-controlling agent may be added to the aluminum compound or may be contained in the aluminum compound as an impurity.

The shape-controlling agent plays an important role in plate crystal growth. In a molybdenum oxide flux method, molybdenum oxide reacts with an aluminum compound to form aluminum molybdate. A change in chemical potential in the decomposition process of the aluminum molybdate is a driving force for crystallization, thus forming polyhedral particles having a hexagonal bipyramidal geometry with well-developed euhedral (113) faces. In the production method according to the embodiment, the shape-controlling agent is seemingly localized near the particle surfaces during the growth process of α-alumina to significantly inhibit the growth of the euhedral (113) faces. This seems to result in a relative increase in growth rate along a crystal orientation in the plane direction to allow the (001) or (006) face to grow, thereby enabling the formation of the plate-like shape. The use of the molybdenum compound as a flux agent further facilitates the formation of the plate-like alumina particles having a high degree of a crystallization and containing molybdenum.

The above-mentioned mechanism is just a guess. Even if the effect of the present invention is obtained by a mechanism different from the above mechanism, it is included in the technical scope of the present invention.

Regarding the type of the shape-controlling agent, at least one selected from the group consisting of silicon, silicon compounds, and germanium compounds is preferably used from the point of view that the plate-like alumina particles having a higher aspect ratio, better dispersibiiity, and better productivity can be produced.

### (Silicon or Silicon Compound)

The silicon or the silicon element-containing silicon compound is not particularly limited, and a known one can be used. Specific examples of silicon or the silicon compound include metal silicon; artificially synthesized silicon compounds, such as organic silanes, silicon resins, fine silica particles, silica gel, mesoporous silica, SiC, mullite; and naturally occurring silicon compounds, such as biosilica. Among these, organic silanes, silicon resins, and fine silica particles are preferably used from the point of view that these can be more uniformly combined or mixed with the aluminum compound. These silicon and silicon compounds may be used alone or in combination of two or more. Additionally, these may be used in combination with another shape-controlling agent as long as the effect of the present invention is not impaired.

Examples of the shape of silicon or the silicon compound that can be suitably used include, but are not particularly limited to, spherical shapes, indefinite shapes, high-aspect-ratio structures (for example, wires, fibers, ribbons, and tubes), and sheets.

### (Germanium Compound)

The raw-material germanium compound used as a shape-controlling agent is not particularly limited, and a known one can be used. Specific examples of the raw-material germanium compound include germanium metal, germanium dioxide, germanium monoxide, germanium tetrachloride, Ge—C bond-containing organic germanium compounds. The raw-material germanium compounds may be used alone or in combination of two or more. Additionally, these may be used in combination with another shape-controlling agent as long as the effect of the present invention is not impaired.

Examples of the shape of the raw-material germanium compound that can be suitably used include, but not particularly limited to, spherical shapes, indefinite shapes, high-aspect-ratio structures (for example, wires, fibers, ribbons, and tubes), and sheets.

### (Potassium Compound)

A potassium compound may further be used in addition to the at least one shape-controlling agent selected from the group consisting of silicon, silicon compounds, and germanium compounds.

Examples of the potassium compound include, but are not particularly limited to, potassium chloride, potassium chlorite, potassium chlorate, potassium sulfate, potassium bisulfate, potassium sulfite, potassium bisulfite, potassium nitrate, potassium carbonate, potassium bicarbonate, potassium acetate, potassium oxide, potassium bromide, potassium bromate, potassium hydroxide, potassium silicate, potassium phosphate, dipotassium phosphate, potassium sulfide, potassium hydrogen sulfide, potassium molybdate, and potassium tungstate. In this case, the aforementioned potassium compounds include isomers, as in the case of molybdenum compounds. Of these, potassium carbonate, potassium bicarbonate, potassium oxide, potassium hydroxide, potassium chloride, potassium sulfate, or potassium molybdate is preferably used. Potassium carbonate, potassium bicarbonate, potassium chloride, potassium sulfate, or potassium molybdate is more preferably used. The above-mentioned potassium compounds may be used alone or in combination of two or more. Potassium molybdate (K₂MoₙO₃ₙ₊₁, n=1 to 3) contains molybdenum and thus can have the function as the molybdenum compound.

### (Molybdenum Compound)

The molybdenum compound contains molybdenum element and functions as a flux agent in the growth of the α-crystalline phase of alumina, as described below.

Examples of the molybdenum compound include, but are not particularly limited to, molybdenum oxides and compounds each containing an acid radical anion (MoOₓⁿ⁻) formed by a bond between molybdenum metal and oxygen.

Examples of the compounds each containing the acid radical anion (MoOₓⁿ⁻) include, but are not particularly limited to, molybdic acid, sodium molybdate, potassium molybdate, lithium molybdate, H₃PMo₁₂O₄₀, H₃SiMo₁₂O₄₀, NH₄Mo₇O₁₂, and molybdenum disulfide.

The molybdenum compound can contain silicon. In this case, the molybdenum compound containing silicon acts as both of the flux agent and the shape-controlling agent.

Among the above-mentioned molybdenum compounds, molybdenum oxide is preferably used from the viewpoint of easy sublimation and cost. The above-mentioned molybdenum compounds may be used alone or in combination of two or more.

The amounts of the aluminum compound, the molybdenum compound, and silicon, the silicon compound, or the germanium compound used are not particularly limited. Preferably, 50% or more by mass of the aluminum compound in terms of Al₂O₃, 40% or less by mass of the molybdenum compound in terms of MoO₃, and 0.1% or more by mass and 10% or less by mass of silicon, the silicon compound, or the germanium compound in terms of SiO₂ or GeO₂ based on 100% by mass of the total amount of the raw materials on an oxide basis can be mixed together to prepare a mixture, and the mixture can be fired. More preferably, 70% or more by mass and 99% or less by mass of the aluminum compound in terms of Al₂O₃, 2% or more by mass and 15% or less by mass of the molybdenum compound in terms of MoO₃, and 0.5% or more by mass and less than 7% by mass of silicon, the silicon compound, or the germanium compound in terms of SiO₂ or GeO₂ based on 100% by mass of the total amount of the raw materials on an oxide basis can be mixed together to prepare a mixture, and the mixture can be fired. Even more preferably, 80% or more by mass and 94.5% or less by mass of the aluminum compound in terms of Al₂O₃, 1.5% or more by mass and 7% or less by mass of the molybdenum compound in terms of MoO₃, and 0.8% or more by mass and 4% or less by mass of silicon, the silicon compound, or the germanium compound in terms of SiO₂ or GeO₂ based on 100% by mass of the total amount of the raw materials on an oxide basis can be mixed together to prepare a mixture, and the mixture can be fired.

The above-mentioned numerical ranges of the amounts of raw materials used can be appropriately combined within the range where the sum total of the contents is not more than 100% by mass.

The use of the compounds within the above ranges facilitates the production of the plate-like alumina particles having a thickness of 0.01 to 5 μm, an average particle size of 0.1 to 500 μm, and an aspect ratio, which is the ratio of the particle size to the thickness, of 5 to 500, the longitudinal relaxation time T₁ being 5 seconds or more.

In the case where the mixture further contains the above-mentioned potassium compound, the amount of the potassium compound used is not particularly limited. Preferably, 5% or less by mass of the potassium compound in terms of K₂O based on 100% by mass of the total amount of the raw materials on an oxide basis can be mixed. More preferably, 0.01% or more by mass and 3% or less by mass of the potassium compound in terms of K₂O based on 100% by mass of the total amount of the raw materials on an oxide basis can be mixed. Even more preferably, 0.05% or more by mass and 1% or less by mass of the potassium compound in terms of K₂O based on 100% by mass of the total amount of the raw materials on an oxide basis can be mixed.

Regarding a potassium compound fed as a raw material or formed by reaction in the course of a heating process for firing, a water-soluble potassium compound, such as potassium molybdate, does not evaporate even in a firing temperature range and can be easily recovered by washing after firing. Thus, the amount of the molybdenum compound released outside a firing furnace can be reduced, and the production cost can also be significantly reduced.

The aluminum compound, the molybdenum compound, silicon or the silicon compound, the germanium compound, and the potassium compound are used in such a manner that the total of the amounts used on an oxide basis is not more than 100% by mass.

### [Firing Step]

The firing step is a step of firing the aluminum compound in the presence of the molybdenum compound and the shape-controlling agent. The firing step may be a step of firing the mixture prepared in the mixing step.

The plate-like alumina particles according to the embodiment are produced, for example, by firing the aluminum compound in the presence of the molybdenum compound and the shape-controlling agent. As described above, this production method is called the flux method.

The flux method is classified as a solution method. Specifically, the flux method is a method of crystal growth utilizing the fact that the crystal-flux two-component phase diagram exhibits a eutectic type. The mechanism of the flux method is assumed to be as follows: Heating a mixture of a solute and a flux forms the liquid phases of the solute and the flux. Since the flux is a melting agent, in other words, since the solute-flux two-component phase diagram exhibits a eutectic type, the solute melts at a lower temperature than its melting point to form the liquid phase. When the flux is evaporated in this state, the concentration of the flux is reduced, in other words, the effect of the flux on lowering the melting point of the solute is reduced. The evaporation of the flux acts as a driving force for the crystal growth of the solute (flux evaporation method). Alternatively, cooling the liquid phases of the solute and flux enables the crystal growth of the solute (slow cooling method).

The flux method has the advantages, for example, that the crystals can grow at a much lower temperature than the melting point, the crystal structure can be accurately controlled, and polyhedral crystals having euhedral forms can be formed.

In the production of α-alumina particles by the flux method using a molybdenum compound as the flux, the mechanism is not fully clear, but it is presumed to be due to the following mechanism, for example: When the aluminum compound is fired in the presence of the molybdenum compound, aluminum molybdate is first formed. At this time, the aluminum molybdate grows α-alumina crystals at a lower temperature than the melting point of alumina, as can be understood from the above description. Then, for example, the evaporation of the flux decomposes aluminum molybdate to enable the crystals to grow, thereby forming α-alumina particles. That is, the molybdenum compound functions as the flux, and α-alumina particles are produced via the aluminum molybdate intermediate.

In the production of α-alumina particles by the flux method when potassium compound is further used as a shape-controlling agent, the mechanism is not fully clear, but it is presumed to be due to the following mechanism, for example. First, the molybdenum compound reacts with the aluminum compound to form aluminum molybdate. Then, for example, aluminum molybdate decomposes into molybdenum oxide and alumina. At the same time, the molybdenum compound including the molybdenum oxide formed by the decomposition reacts with the potassium compound to form potassium molybdate. The plate-like alumina particles according to the embodiment can be formed by crystal growth of alumina in the presence of the molybdenum compound including the potassium molybdate.

The use of the flux method described above facilitates the production of the plate-like alumina particles having an aspect ratio of 5 to 500, in which in solid-state ²⁷Al NMR analysis, a longitudinal relaxation time T₁ for a peak of six-coordinated aluminum at 10 to 30 ppm is 5 seconds or more at a static magnetic field strength of 14.1 T.

The firing method is not particularly limited, and can be performed by a known and commonly used method. At a firing temperature of higher than 700° C., the aluminum compound reacts with the molybdenum compound to form aluminum molybdate. At a firing temperature of 900° C. or higher, aluminum molybdate decomposes, and the plate-like alumina particles are formed by the action of the shape-controlling agent. In the plate-like alumina particles, when aluminum molybdate decomposes into alumina and molybdenum oxide, the molybdenum compound is seemingly incorporated into the aluminum oxide particles.

Moreover, at a firing temperature of 900° C. or higher, the molybdenum compound (for example, molybdenum trioxide) formed by the decomposition of the aluminum molybdate seems to react with the potassium compound to form potassium molybdate.

At the time of firing, the states of the aluminum compound, the shape-controlling agent, and the molybdenum compound are not particularly limited. The molybdenum compound and the shape-controlling agent need only be present in the same space where they can act on the aluminum compound. Specifically, powders of the molybdenum compound, the shape-controlling agent, and the aluminum compound may be simply mixed, may be mechanically mixed, for example, using a grinder, or may be mixed, for example, using a mortar. The mixing may be performed in a dry or wet state.

The firing temperature condition is not particularly limited and is appropriately determined in accordance with the average particle size and the aspect ratio of the intended plate-like alumina particles and the numerical dispersion of the longitudinal relaxation time T₁. With respect to the firing temperature, typically, the maximum temperature is preferably 900° C. or higher, which is the decomposition temperature of aluminum molybdate (Al₂(MoO₄)₃), more preferably 1,200° C. or higher, at which the plate-like alumina particles that exhibit a longitudinal relaxation time T₁ of 5 seconds or more (high crystallinity) can be easily formed.

To control the shape of α-alumina obtained by firing, typically, high-temperature firing is performed at 2,000° C. or higher, which is close to the melting point of α-alumina, in some cases. However, there are major issues for industrial use in view of load on the firing furnace and fuel cost.

The production method according to the embodiment can be performed even at a high temperature of higher than 2,000° C. However, α-alumina having a plate-like shape with a high degree of α crystallization and a high aspect ratio can be formed even at a temperature of 1,600° C. or lower, which is much lower than the melting point of α-alumina, regardless of the shape of the precursor.

According to an embodiment of the present, invention, the plate-like alumina particles having a high aspect ratio and a degree of α crystallization of 90% or more can be efficiently formed at low cost even at a maximum firing temperature of 900° C. to 1,600° C. The firing is preferably performed at a maximum temperature of 950° C. to 1,500° C., more preferably 1,000° C. to 1,400° C., most preferably 1,200° C. to 1,400° C.

Regarding the firing time, the heat-up time to the maximum temperature is preferably in the range of 15 minutes to 10 hours, and the holding time at the maximum firing temperature is preferably in the range of 5 minutes to 30 hours. To efficiently form the plate-like alumina particles, the firing holding time is more preferably about 10 minutes to about 15 hours.

By selecting a maximum temperature of 1,200° C. to 1,400° C. and a firing holding time of 10 minutes to 15 hours, it is possible to easily form the plate-like alumina particles in which the longitudinal relaxation time T₁ is 5 seconds or more (high crystallinity).

The firing atmosphere is not particularly limited. Preferred examples thereof include oxygen-containing atmospheres, such as air and oxygen; and inert atmospheres, such as nitrogen, argon, and carbon dioxide. An air atmosphere is more preferred in terms of cost.

A device for firing is not necessarily limited, and what is called a firing furnace can be used. The firing furnace is preferably composed of a material that does not react with sublimated molybdenum oxide. Moreover, a highly gastight firing furnace is preferably used in order to efficiently use molybdenum oxide.

### [Molybdenum Removal Step]

The method for producing the plate-like alumina particles may further include, after the firing step, a molybdenum removal step of removing at least part of molybdenum, as needed.

As described above, molybdenum sublimes during the firing. Thus, for example, by the firing time and the firing temperature, the amount of molybdenum present in the surface layers of the plate-like alumina particles can be controlled. Moreover, the amount and state of molybdenum present (in inner layers) other than the surface layers of the alumina particles can be controlled.

Molybdenum can adhere to the surfaces of the plate-like alumina particles. As a means other than the above-mentioned sublimation, the molybdenum can be removed by washing with water, an aqueous ammonia solution, an aqueous sodium hydroxide solution, or an aqueous acidic solution. The molybdenum need not necessarily be removed from the plate-like alumina particles. However, the molybdenum present at least on the surfaces is preferably removed because when the alumina is dispersed and used in a dispersion medium, such as any of various binders, the original properties of the alumina can be sufficiently provided and no inconvenience caused by the molybdenum present on the surfaces can occur.

In this case, the molybdenum content can be controlled, for example, by appropriately changing the concentration and amount of water, an aqueous ammonia solution, an aqueous sodium hydroxide solution, or an aqueous acidic solution used, the washing portion, and the washing time.

### [Grinding Step]

In the fired product, the preferred particle size range is not satisfied because of their aggregation of the plate-like alumina particles, in some cases. Thus, the plate-like alumina particles may be ground, as needed, so as to satisfy the preferred particle size range.

A method for grinding the fired product is not particularly limited. A conventionally known grinding method can be used. Examples thereof include ball mills, jaw crushers, jet mills, disc mills, SpectroMills, grinders, and mixer mills.

### [Classification Step]

The plate-like alumina particles are preferably subjected to classification treatment in order to adjust the average particle size to improve the flowability of the powder or in order to suppress an increase in viscosity when the plate-like alumina particles are mixed with a binder for the formation of a matrix. The term “classification treatment” refers to an operation to classify particles into groups in accordance with their particle size.

The classification may be either wet or dry. Dry classification is preferred in view of productivity.

Examples of the dry classification include sieve classification and air classification using the difference between the centrifugal force and the fluid drag. Air classification is preferred in terms of classification accuracy, and can be performed with a classifier, such as an airflow classifier using the Coanda effect, a swirling airflow classifier, a forced vortex centrifugal classifier, or a semi-free vortex centrifugal classifier.

The grinding step and the classification step described above can be performed in a necessary stage including before and after an organic compound layer formation step described below. For example, the average particle size of the resulting plate-like alumina particles can be adjusted by the presence or absence of these grinding and classification and the selection of their conditions.

The plate-like alumina particles according to the embodiment or the plate-like alumina particles formed by the production method according to the embodiment, with little or no aggregation, are preferred from the point of view that they can easily provide their original properties, have better handleability, and have better dispersibility when they are dispersed in a dispersion medium and used. In the method for producing the plate-like alumina particles, when the plate-like alumina particles with little or no aggregation can be produced without performing the grinding step or classification step, those steps need not be performed, and the plate-like alumina particles having desired excellent properties can be produced with high productivity, which is preferred.

### [Organic Compound Layer Formation Step]

In an embodiment, the method for producing the plate-like alumina particles may further include the organic compound layer formation step. The organic compound layer formation step is usually performed after the firing step or the molybdenum removal step.

A method for forming an organic compound layer is not particularly limited, and a known method can be employed, as appropriate. An example thereof is a method in which an organic compound-containing liquid is brought into contact with a molybdenum-containing plate-like alumina particles and drying is performed.

As the organic compound that can be used for the formation of the organic compound layer, the above-mentioned organic compound can be used.

### <Resin Composition>

As an embodiment of the present invention, a resin composition containing a resin and the plate-like alumina particles according to the embodiment is provided. Examples of the resin include, but are not particularly limited to, thermosetting resins and thermoplastic resins.

The resin composition can be cured into a cured product of the resin composition, or can be cured and molded into a molded product of the resin composition. For molding, the resin composition can be subjected to processing, such as melting and kneading, as appropriate. Examples of a molding method include compression molding, injection molding, extrusion molding, and foam molding. Of these, extrusion molding with an extruder is preferred. Extrusion molding with a twin-screw extruder is more preferred.

### <Method for Producing Resin Composition>

According to an embodiment of the present invention, a method for producing a resin composition is provided.

The production method includes a step of mixing plate-like alumina particles according to an embodiment with a resin.

As the plate-like alumina particles, the above-mentioned particles can be used. Thus, the description thereof is omitted here.

As the plate-like alumina particles, those having been surface-treated can be used.

Only one type of plate-like alumina particles may be used. Alternatively, two or more types may be used in combination.

Moreover, the plate-like alumina particles and other fillers (for example, alumina, spinel, boron nitride, aluminum nitride, magnesium oxide, or magnesium carbonate) may be used in combination.

The plate-like alumina particle content is preferably 5% to 95% by mass, more preferably 10% to 90% by mass, even more preferably 30% to 80% by mass based on 100% by mass of the total mass of the resin composition. A plate-like alumina particle content of 5% or more by mass enables the high thermal conductivity of the plate-like alumina particles to be efficiently provided and thus is preferred. A plate-like alumina particle content of 95% or less by mass enables the production of the resin composition having excellent moldability and thus is preferred.

### [Resin]

Examples of the resin include, but are not particularly limited to, thermoplastic resins and thermosetting resins.

The thermoplastic resin is not particularly limited, and a known and commonly used resin used as a molding material or the like can be used. Specific examples thereof include polyethylene resins, polypropylene resins, poly(methyl methacrylate) resins, poly(vinyl acetate) resins, ethylene-propylene copolymers, ethylene-vinyl acetate copolymers, poly(vinyl chloride) resins, polystyrene resins, polyacrylonitrile resins, polyamide resins, polycarbonate resins, polyacetal resins, poly(ethylene terephthalate) resins, poly(phenylene oxide) resins, poly(phenylene sulfide) resins, polysulfone resins, poly(ether sulfone) resins, poly(ether ether ketone) resins, poly(aryl sulfone) resins, thermoplastic polyimide resins, thermoplastic urethane resins, poly(aminobismaleimide) resins, poly(amide-imide) resins, poly(ether imide) resins, bismaleimide triazine resins, polymethylpentene resins, fluorocarbon resins, liquid crystal polymers, olefin-vinyl alcohol copolymers, ionomer resins, polyarylate resins, acrylonitrile-ethylene-styrene copolymers, acrylonitrile-butadiene-styrene copolymers, and acrylonitrile-styrene copolymers.

The thermosetting resin is a resin that has the property of becoming substantially insoluble and non meltable when cured by heating or by means of radiation or a catalyst. Typically, a known and commonly used resin used for, for example, a molding material can be used. Specific examples thereof include novolac-type phenolic resins, such as phenolic novolac resins and cresol novolac resins; phenolic resins, such as resol-type phenolic resins, e.g., unmodified resol phenolic resins and oil-modified resol phenolic resins modified with, for example, tung oil, linseed oil, or walnut oil; bisphenol-type epoxy resins, such as bisphenol-A epoxy resins and bisphenol F epoxy resins; novolac-type epoxy resins, such as aliphatic chain-modified bisphenol-type epoxy resins, novolac epoxy resins, and cresol novolac epoxy resins; epoxy resins, such as biphenyl-type epoxy resins and poly(alkylene glycol)-type epoxy resins; triazine ring-containing resins, such as urea resins and melamine resins; vinyl resins, such as (meth)acrylic resins and vinyl ester resins; unsaturated polyester resins, bismaleimide resins, polyurethane resins, diallyl phthalate resins, silicone resins, benzoxazine ring-containing resins, and cyanate ester resins.

The above-mentioned resins may be used alone or in combination of two or more. In this case, two or more thermoplastic resins may be used. Two or more thermosetting resins may be used. One or more thermoplastic resins and one or more thermosetting resins may be used.

The resin content is preferably 5% to 90% by mass, more preferably 10% to 70% by mass based on 100% by mass of the total mass of the resin composition. A resin content of 5% or more by mass is preferred because the resin composition has excellent moldability. A resin content of 90% or less by mass is preferred because high thermal conductivity can be obtained as a compound by molding.

### [Curing Agent]

A curing agent may be mixed with the resin composition, as needed.

The curing agent is not particularly limited, and a known curing agent can be used.

Specific examples thereof include amine compounds, amide compounds, acid anhydride compounds, phenolic compounds.

Examples of the amine compounds include diaminodiphenylmethane, diethylenetriamine, triethylenetetramine, diaminodiphenyl Sulfone, isophoronediamine, imidazole, BF₃-amine complexes, and guanidine derivatives.

Examples of the amide compounds include dicyandiamide and polyamide resins synthesized from a linolenic acid dimer and ethylenediamine.

Examples of the acid anhydride compounds include phthalic anhydride, trimellitic anhydride, pyromellitic anhydride, maleic anhydride, tetrahydrophthalic anhydride, methyltetrahydrophthalic anhydride, methyl nadic anhydride, hexahydrophthalic anhydride, and methylhexahydrophthalic anhydride.

Examples of the phenolic compounds include phenolic novolac resins, cresol novolac resins, aromatic hydrocarbon formaldehyde resin-modified phenolic resins, dicyclopentadiene phenol addition-type resins, phenol aralkyl resins (Xylok resins), polyhydric phenolic novolac resins, typified by resorcinol novolac resins, synthesized from polyhydric compounds and formaldehyde, naphthol aralkyl resins, trimethylolmethane resins, tetraphenylolethane resins, naphthol novolac resins, naphthol-phenol co-condensed novolac resins, naphthol-cresol co-condensed novolac resins, and polyhydric phenolic compounds, such as biphenyl-modified phenolic resins (polyhydric phenolic compounds in which phenolic nuclei are linked by bismethylene groups), biphenyl-modified naphthol resins (polyhydric naphthol compounds in which phenol nuclei are linked by bismethylene groups), aminotriazine-modified phenolic resins (polyhydric phenolic compounds in which phenol nuclei are linked by, for example, melamine or benzoguanamine), and alkoxy group-containing aromatic ring-modified novolac resins (polyhydric phenolic compounds in which phenol nuclei and alkoxy group-containing aromatic rings are linked by formaldehyde).

The above-mentioned curing agents may be used alone or in combination of two or more.

### [Curing Accelerator]

A curing accelerator may be mixed with the resin composition, as needed.

The curing accelerator has the function of promoting curing when the composition is cured.

Examples of the curing accelerator include, but are not particularly limited to, phosphorous compounds, tertiary amines, imidazole, metal salts of organic acids, Lewis acids, and amine complex salts.

The above-mentioned curing accelerators may be used alone or in combination of two or more.

### [Curing Catalyst]

A curing catalyst may be mixed with the resin composition.

The curing catalyst has the function of allowing the curing reaction of an epoxy group-containing compound to proceed in place of the curing agent.

The curing catalyst is not particularly limited, and a thermal polymerization initiator or an active energy ray polymerization initiator, which is known and commonly used, can be used.

The curing catalysts may be used alone or in combination of two or more.

### [Viscosity Modifier]

A viscosity modifier may be mixed with the resin composition.

The viscosity modifier has the function of adjusting the viscosity of the composition.

Examples of the viscosity modifier that can be used include, but are not particularly limited to, organic polymers, polymer particles, and inorganic particles.

These viscosity modifiers may be used alone or in combination of two or more.

### [Plasticizer]

A plasticizer may be mixed with the resin composition, as needed.

The plasticizer has the function of improving, for example, the processability, the flexibility, and the weather resistance of a thermoplastic synthetic resin.

Examples of the plasticizer that can be used include, but are not particularly limited to, phthalate esters, adipate esters, phosphate esters, trimellitate esters, polyesters, polyolefins, and polysiloxanes.

The above-mentioned plasticizers may be used alone or in combination of two or more.

### [Mixing]

The resin composition according to the embodiment is prepared by mixing the plate-like alumina particles, the resin, and, if necessary, other components together. A method of the mixing is not particularly limited, and the mixing is performed by a known and commonly used method.

In the case where the resin is a thermosetting resin, an example of a method of mixing a general-purpose thermosetting resin with the plate-like alumina particles and so forth is a method in which desired amounts of the thermosetting resin mixed, the plate-like alumina particles, and, if necessary, other components are sufficiently mixed together using, for example, a mixer and then kneaded with, for example, a three-roll mill to prepare a flowable liquid composition. An example of another method of mixing a thermosetting resin with the plate-like alumina particles and so forth according to another embodiment is a method in which desired amounts of the thermosetting resin, the plate-like alumina particles, and, if necessary, other components are sufficiently mixed using, for example, a mixer, then melt-knead with, for example, a mixing roll or an extruder, and cooled to prepare a solid composition.

Regarding the mixed state, in the case where a curing agent, a catalyst, and so forth are incorporated therein, it is sufficient that the thermosetting resin and those components are sufficiently and uniformly mixed. Preferably, the plate-like alumina particles are also uniformly dispersed and mixed.

In the case where the resin is a thermoplastic resin, an example of a method of mixing a general-purpose thermoplastic resin with the plate-like alumina particles and so forth is a method in which the thermosetting resin, the plate-like alumina particles, and, if necessary, other components are mixed together using any of various mixers, such as a tumbler and a Henschel mixer, in advance, and then melt-kneaded with a mixer, such as a Banbury mixer, a roll, a Brabender, a single-screw kneading extruder, a twin-screw kneading extruder, a kneader, or a mixing roll. The temperature during the melt-kneading is usually, but not particularly limited to, in the range of 100° C. to 320° C.

A coupling agent may be externally added to the resin composition because the flowability of the resin composition and the filling properties of fillers, such as the plate-like alumina particles, are enhanced. The external addition of the coupling agent can enhance the adhesion between the resin and the plate-like alumina particles and reduce the interfacial thermal resistance between the resin and the plate-like alumina particles to improve the thermal conductivity of the resin composition.

Examples of the organic silane compound include methyltrimethoxysilane, dimethyldimethoxysilane, ethyltrimethoxysilane, ethyltriethoxysilane, n-propyltrimethoxysilane, n-propyltriethoxysilane, alkyltrimethoxysilanes whose alkyl groups each have 1 to 22 carbon atoms, such as isopropyltrimethoxysilane, isopropyltriethoxysilane, pentyltrimethoxysilane, hexyltrimethoxysilane, and octenyltrimethoxysilane, alkyltrichlorosilanes, 3,3,3-trifluoropropyltrimethoxysilane, tridecafluoro-1,1,2,2-tetrahydrooctyl)trichlorosilane, phenyltrimethoxysilane, phenyltriethoxysilane, p-chloromethylphenyltrimethoxysilane, p-chloromethylphenyltriethoxysilane, epoxysilanes, such as γ-glycidoxypropyltrimethoxysilane, γ-glycidoxypropyltriethoxysilane, β-(3,4-epoxycyclohexyl)ethyltrimethoxysilane, and glycidoxyoctyltrimethoxysilane, aminosilanes, such as γ-aminopropyltriethoxysilane, N-β(aminoethyl)γ-aminopropyltrimethoxysilane, N-β(aminoethyl)γ-aminopropylmethyldimethoxysilane, γ-aminopropyltrimethoxysilane, and γ-ureidopropyltriethoxysilane, mercaptosilanes, such as 3-mercaptopropyltrimethoxysilane, vinylsilanes, such as p-styryltrimethoxysilane, vinyltrichlorosilane, vinyltris(β-methoxyethoxy)silane, vinyltrimethoxysilane, vinyltriethoxysilane, γ-methacryloxypropyltrimethoxysilane, and methacryloxyoctyltrimethoxysilane, and epoxy-, amino-, and vinyl-based polymeric silanes. The above-mentioned organic silane compounds may be contained alone or in combination of two or more.

The above-mentioned coupling agents may be used alone or in combination of two or more.

The amount of the coupling agent added is preferably, but not necessarily, 0.01% to 5% by mass, more preferably 0.1% to 3% by mass based on the mass of the resin.

According to an embodiment, the resin composition is used for a thermally-conductive material.

The plate-like alumina particles contained in the resin composition allows the resin composition to have excellent thermal conductivity; thus, the resin composition is preferably used as an insulating heat-dissipating member. This can improve the heat dissipation function of a device and can contribute to reductions in the size and weight and an improvement in performance of the device.

### <Method for Producing Cured Product>

According to an embodiment of the present invention, a method for producing a cured product is provided. The production method includes curing the resin composition produced as described above.

The curing temperature is preferably, but not necessarily, 20° C. to 300° C., more preferably 50° C. to 200° C.

The curing time is preferably, but not necessarily, 0.1 to 10 hours, more preferably 0.2 to 3 hours.

The shape of the cured product varies depending on the desired application and can be appropriately designed by those skilled in the art.

### EXAMPLES

While the present invention will be described in more detail below with reference to the examples, the present invention is not limited to the examples below.

### <<Evaluation>>

Powders prepared in Examples 1 to 7 and Comparative examples 1 to 4 were used as samples, and the following evaluations were performed.

Measurement methods are described below.

### [Measurement of Average Particle Size L of Plate-Like Alumina Particles]

The average particle size d50 (μm) was determined with a HELOS (H3355) and RODOS laser diffraction particle size distribution analyzer, R3: 0.5/0.9-175 μm (available from Japan Laser Corp.) at a dispersion pressure of 3 bar and a vacuum pressure of 90 mbar and defined as an average particle size L.

### [Measurement of Thickness T of Plate-Like Alumina Particles]

The thicknesses of 50 plate-like alumina particles were measured with a scanning electron microscope (SEM), and the average value was defined as a thickness T (μm).

### [Aspect Ratio L/T]

The aspect ratio was determined from the following formula.

Aspect ratio=average particle size L of plate-like alumina particles/thickness T of plate-like alumina particles

### [Analysis of Degree of α Crystallization]

Each of the prepared samples was placed on a measurement sample holder having a depth of 0.5 mm, filled thereinto so as to be made flat at a constant load, and placed on a wide-angle X-ray diffractometer (Ultima IV, available from Rigaku Corporation). Measurement was performed under the following conditions: Cu/Kα radiation, 40 kV/40 mA, scan speed: 2°/min, and scan range: 10° to 70°. The degree of α crystallization was determined from the ratio of the strongest peak height of α-alumina to the strongest peak height of transition alumina.

### [Measurement of Coordination Number by NMR]

Solid-state ²⁷Al NMR analysis was performed with JNM-ECA600, available from JEOL Resonance Inc., at a static magnetic field strength of 14.1 T. Each sample was collected in a 4-mm-diameter sample tube for solid-state NMR, and then measurement was performed. For each sample, the 90 degree pulse width was measured, and then relaxation time measurement by saturation recovery and single-pulse measurement were performed.

In the case where the peak maximum of six-coordinated aluminum in a commercially available γ-alumina reagent (Kanto Chemical Co., Inc.) was observed at 14.6 ppm, a peak detected at 10 to 30 ppm was estimated to be a peak of six-coordinated aluminum, and a peak detected at 60 to 90 ppm was estimated to be a peak of four-coordinated aluminum. When the intensity of the peak at the four-coordination position was higher than or equal to the baseline noise level, the peak was considered to be “detected”. When it was equal to the baseline noise level, the peak was considered to be “not detected”.

The conditions are described below.

MAS rate: 15 kHz

Probe: SH60T4 (available from JEOL Resonance Inc.)

The measurement conditions for the single-pulse measurement at 14.1 T are described below.

Pulse delay time (s): (T₁ (s) determined by relaxation recovery×3)

Pulse width (μs): 90 degree pulse width (μs) of six-coordinated aluminum in each sample/3

Number of acquisitions: 8

Temperature: 46° C.

### [Measurement of Longitudinal Relaxation Time T₁ by NMR]

The longitudinal relaxation time T₁ for the peak of six-coordinated aluminum detected at 10 to 30 ppm was determined by relaxation recovery at 14.1 T.

The conditions are described below.

Pulse delay time (s): 0.5

Relaxation delay after saturation (s): 0.5 to 100,

Exponential intervals: 16 points

Number of acquisitions: 1

Temperature: 46° C.

### [Measurement of Coordination Number by High Magnetic Field NMR]

Solid-state ²⁷Al NMR analysis was performed with JNM-ECZ900R, available from JEOL Resonance Inc., at a static magnetic field strength of 21.1 T. Each sample was collected in a 3.2-mm-diameter sample tube (ZrO₂) for solid-state NMR, and then single-pulse measurement was performed.

As with the solid-state ²⁷Al NMR analysis at a static magnetic field strength of 14.1 T, in the case where the peak maximum of six-coordinated aluminum in a commercially available γ-alumina reagent (Kanto Chemical Co., Inc.) was observed at 14.6 ppm, a peak detected at 10 to 30 ppm was estimated to be a peak of six-coordinated aluminum, and a peak detected at 60 to 90 ppm was estimated to be a peak of four-coordinated aluminum. When the intensity of the peak at the four-coordination position was higher than or equal to the baseline noise level, the peak was considered to be “detected”. When it was equal to the baseline noise level, the peak was considered to be “not detected (-)”.

The measurement: conditions for the single-pulse measurement at 21.1 T were described below.

MAS Rate: 20 kHz

Probe: single-tuned MAS probe (available from Probe Laboratory Inc.)

Pulse delay time (s): T; (s) determined by relaxation recovery at a static magnetic field of 14.1 T×9

Pulse width (μs): 90 degree pulse width (μs) of each sample/3

Number of acquisitions: 8

Temperature: 46° C.

### [Analysis of Amount of Mo Contained in Plate-Like Alumina Particles]

About 70 mg of each of the prepared samples was placed on filter paper, covered with a PP film, and subjected to composition analysis with a Primus IV X-ray fluorescence spectrometer (available from Rigaku Corporation).

The amount of molybdenum determined from the results of the XRF analysis was converted into a value on a molybdenum trioxide basis (% by mass) based on 100% by mass of the plate-like alumina particles (100% by mass of the total mass of the plate-like alumina particles).

### [Processing Stability]

First, 66% by mass of each of the prepared samples and 34% by mass of a poly(phenylene sulfide) resin (LR-100G PPS resin, available from DIC Corporation) were mixed together to prepare a total of 5 kg of a mixture. Then 5 kg of the mixture was melt-kneaded with a twin-screw extruder having a screw diameter of 40 mm and L/D=45 at a feed rate of 15 kg/h, an extruder temperature of 320° C., and a screw rotation speed of 150 rpm. In the case of a sample in which the diameter of a strand emerging from a die was not stable and surging occurred or a sample in which asperities and streaks were observed on the surface of a strand because of, for example, foaming or foreign matter, the processing stability was evaluated as “×”. In the case of a sample in which the above-mentioned phenomenon was not observed, the processing stability was evaluated as “◯”.

### [Shape Retention Rate]

First, 66% by mass of each of the prepared samples and 34% by mass of a poly(phenylene sulfide) resin (LR-100G PPS resin, available from DIC Corporation) were mixed together to prepare a total of 5 kg of a mixture. Then 5 kg of the mixture was melt-kneaded with a twin-screw extruder having a screw diameter of 40 mm and L/D=45 at a feed rate of 15 kg/h, an extruder temperature of 320° C., and a screw rotation speed of 150 rpm. After the melt-kneaded, the resulting strand was cut with a pelletizer into pellets having a long diameter of 3 mm and a length of 5 mm. Then 5 g of the pellets were collected, placed in a crucible, heated at 700° C. for 3 hours to ash the pellets. The average particle size d50 (μm) of the ashed powdery sample was measured with a laser diffraction particle size distribution analyzer. The resulting value was defined as the average particle size after the melt-kneaded with a twin-screw extruder. Separately from the above sample, 3 g of a sample before the extrusion kneading (before mixing with the poly(phenylene sulfide) resin) was prepared. The average particle size d50 (μm) thereof was measured in the same way as above. The resulting value was defined as the average particle size before the extrusion kneading.

The shape retention rate (%) of the powder was determined from (average particle size after extrusion kneading/average particle size before extrusion kneading×100).

In the case of a sample having low crystallinity, it is considered that the melt-kneading with the extruder breaks the alumina particles to increase the amount of fine particle components, resulting in a smaller average particle size than that before kneading (the value of the shape retention rate is reduced).

### <<Production of Plate-Like Alumina Particles>>

### Example 1

First, 50 g of aluminum hydroxide (available from Nippon Light Metal Co., Ltd., average particle size: 12 μm), 0.65 g of silicon dioxide (Kanto Chemical Co., Inc.), and 1.72 g of molybdenum trioxide (available from Taiyo Koko Co., Ltd.) were mixed together using a mortar to prepare a mixture. The resulting mixture was placed in a crucible and fired by heating the mixture to 1,200° C. at 5° C./min with a ceramic electric furnace and holding the mixture at 1,200° C. for 10 hours. Subsequently, the mixture was cooled to room temperature at 5° C./min. The crucible was then taken out to give 34.2 g of a light blue powder. The resulting powder was disintegrated with a mortar until it passed through a sieve with 106-μm openings.

Then the resulting powder was dispersed in 150 mL of a 0.5% aqueous ammonia solution. The dispersion was stirred at room temperature (25° C. to 30° C.) for 0.5 hours and filtered to remove the aqueous ammonia solution. The resulting particles were washed with water and dried to remove molybdenum left on the surfaces of the particles to give 33.5 g of a light blue powder.

Table 1 presents the evaluation results. SEM observation of the resulting powder revealed that the resulting powder were plate-like particles having a polygonal plate shape, containing very few aggregates, and having excellent handleability. XRD measurement revealed that a sharp scattering peak originating from α-alumina appeared, a peak originating from alumina crystals other than the α-crystal structure was not observed, the degree of α crystallization was 99% or more (almost 100%), and the plate-like alumina had a dense crystal structure. The results of the quantitative X-ray fluorescence analysis revealed that the resulting particles contained 0.82% by mass molybdenum in terms of molybdenum trioxide. The solid-state ²⁷Al NMR analysis at a static magnetic field strength of 14.1 T and the solid-state ²⁷Al NMR analysis at a static magnetic field strength of 21.1 T revealed that the peak of six-coordinated aluminum was detected in each analysis. The longitudinal relaxation time T₁ for six-coordinated aluminum at a static magnetic field strength of 14.1 T was 7.5 seconds.

### Example 2

First, 33.4 g of a light blue powder was prepared in the same operation as in Example 1, except that the mixture was placed in a crucible and fired by heating the mixture to 1,300° C. at 5° C./min with a ceramic electric furnace and holding the mixture at 1,300° C. for 10 hours.

Table 1 presents the evaluation results. SEM observation of the resulting powder revealed that the resulting powder were plate-like particles having a polygonal plate shape, containing very few aggregates, and having excellent handleability. XPD measurement revealed that a sharp scattering peak originating from α-alumina appeared, a peak originating from alumina crystals other than the α-crystal structure was not observed, the degree of α crystallization was 99% or more (almost 100%), and the plate-like alumina had a dense crystal structure. The results of the quantitative X-ray fluorescence analysis revealed that the resulting particles contained 0.77% by mass molybdenum in terms of molybdenum trioxide. The solid-state ²⁷Al NMR analysis at a static magnetic field strength of 14.1 T and the solid-state ²⁷Al NMR analysis at a static magnetic field strength of 21.1 T revealed that the peak of six-coordinated aluminum was detected in each analysis. The longitudinal relaxation time T₁ for six-coordinated aluminum at a static magnetic field strength of 14.1 T was 9.5 seconds. It was confirmed that the use of a higher firing temperature than that in Example 1 improved the crystal symmetry to provide plate-like alumina particles having high crystallinity.

### Example 3

First, 50 g of aluminum hydroxide (available from Nippon Light Metal Co., Ltd., average particle size: 10 μm), 0.33 g of silicon dioxide (Kanto Chemical Co., Inc.), and 1.72 g of molybdenum trioxide (available from Taiyo Koko Co., Ltd.) were mixed together using a mortar to prepare a mixture. The resulting mixture was placed in a crucible and fired by heating the mixture to 1,400° C. at 5° C./min with a ceramic electric furnace and holding the mixture at 1,400° C. for 10 hours. Except for the above, 33.1 g of a light gray powder was prepared in the same operation as in Example 1.

Table 1 presents the evaluation results. SEM observation of the resulting powder revealed that the resulting powder were plate-like particles having a polygonal plate shape, containing very few aggregates, and having excellent handleability. XRD measurement revealed that a sharp scattering peak originating from α-alumina appeared, a peak originating from alumina crystals other than the α-crystal structure was not observed, the degree of α crystallization was 99% or more (almost 100%), and the plate-like alumina had a dense crystal structure. The results of the quantitative X-ray fluorescence analysis revealed that the resulting particles contained 0.85% by mass molybdenum in terms of molybdenum trioxide. The solid-state ²⁷Al NMR analysis at a static magnetic field strength of 14.1 T and the solid-state ²⁷Al NMR analysis at a static magnetic field strength of 21.1 T revealed that the peak of six-coordinated aluminum was detected in each analysis. The longitudinal relaxation time T₁ for six-coordinated aluminum at a static magnetic field strength of 14.1 T was 9.0 seconds. The results seemingly indicated that the use of a further higher firing temperature than that in Example 1 improved the symmetry of the crystal to provide plate-like alumina particles having higher crystallinity.

### Example 4

First, 16.8 g of a light gray powder was prepared in the same operation as in Example 1, except that 25 g of aluminum hydroxide (available from Nippon Light Metal Co., Ltd., average particle size: 2 μm), 0.49 g of silicon dioxide (Kanto Chemical Co., Inc.), and 0.86 g of molybdenum trioxide (available from Taiyo Koko Co., Ltd.) were mixed together using a mortar to prepare a mixture.

Table 1 presents the evaluation results. SEM observation of the resulting powder revealed that the resulting powder were plate-like particles having a polygonal plate shape, containing very few aggregates, and having excellent handleability. XRD measurement revealed that a sharp scattering peak originating from α-alumina appeared, a peak originating from alumina crystals other than the α-crystal structure was not observed, the degree of α crystallization was 99% or more (almost 100%), and the plate-like alumina had a dense crystal structure. The results of the quantitative X-ray fluorescence analysis revealed that the resulting particles contained 0.85% by mass molybdenum in terms of molybdenum trioxide. The solid-state ²⁷Al NMR analysis at a static magnetic field strength of 14.1 T and the solid-state ²⁷Al NMR analysis at a static magnetic field strength of 2.1.1 T revealed that the peak of six-coordinated aluminum was detected in each analysis. The longitudinal relaxation time T₁ for six-coordinated aluminum at a static magnetic field strength of 14.1 T was 6.5 seconds. Even in the case of plate-like alumina having a smaller average particle size, it was possible to produce the plate-like alumina particles having high crystal symmetry.

### Example 5

First, 33.1 g of a light blue-green powder was prepared in the same operation as in Example 1, except that 50 g of aluminum hydroxide (available from Nippon Light Metal Co., Ltd., average particle size: 12 μm), 0.33 g of silicon dioxide (Kanto Chemical Co., Inc.), and 7.36 g of molybdenum trioxide (available from Taiyo Koko Co., Ltd.) were mixed together using a mortar to prepare a mixture.

Table 1 presents the evaluation results. SEM observation of the resulting powder revealed that the resulting powder were plate-like particles having a polygonal plate shape, containing very few aggregates, and having excellent handleability. XRD measurement revealed that a sharp scattering peak originating from α-alumina appeared, a peak originating from alumina crystals other than the α-crystal structure was not observed, the degree of α crystallization was 99% or more (almost 100%), and the plate-like alumina had a dense crystal structure. The results of the quantitative X-ray fluorescence analysis revealed that the resulting particles contained 1.16% by mass molybdenum in terms of molybdenum trioxide. The solid-state ²⁷Al NMR analysis at a static magnetic field strength of 14.1 T and the solid-state ²⁷Al. NMR analysis at a static magnetic field strength of 21.1 T revealed that the peak of six-coordinated aluminum was detected in each analysis. The longitudinal relaxation time T₁ for six-coordinated aluminum at a static magnetic field strength of 14.1 T was 8.3 seconds. An increase in the amount of the molybdenum compound mixed resulted in a further improvement in crystal symmetry.

### Example 6

First, 33.4 g of a light blue powder was prepared in the same operation as in Example 1, except that 50 g of aluminum hydroxide (available from Nippon Light Metal Co., Ltd., average particle size: 12 μm), 0.49 g of germanium dioxide (available from Mitsubishi Materials Corporation), and 1.72 g of molybdenum trioxide (available from Taiyo Koko Co., Ltd.) were mixed together using a mortar to prepare a mixture.

Table 1 presents the evaluation results. SEM observation of the resulting powder revealed that the resulting powder were plate-like particles having a polygonal plate shape, containing very few aggregates, and having excellent handleability. XRD measurement revealed that a sharp scattering peak originating from α-alumina appeared, a peak originating from alumina crystals other than the α-crystal structure was not observed, the degree of α crystallization was 99% or more (almost 100%), and the plate-like alumina had a dense crystal structure. The results of the quantitative X-ray fluorescence analysis revealed that the resulting particles contained 1.28% by mass molybdenum in terms of molybdenum trioxide. The solid-state ²⁷Al NMR analysis at a static magnetic field strength of 14.1 T and the solid-state ²⁷Al NMR analysis at a static magnetic field strength of 2.1.1 T revealed that the peak of six-coordinated aluminum was detected in each analysis. The longitudinal relaxation time T₁ for six-coordinated aluminum at a static magnetic field strength of 14.1 T was 10.1 seconds. The results indicated that even in the case where the shape-controlling agent was changed to the Ge compound, good values were obtained.

### Example 7

First, 34.3 g of a white powder was prepared in the same operation as in Example 1, except that 50 g of aluminum hydroxide (available from Nippon Light Metal Co., Ltd., average particle size: 12 μm), 1.63 g of germanium dioxide (available from Mitsubishi Materials Corporation), and 1.72 g of molybdenum trioxide (available from Taiyo Koko Co., Ltd.) were mixed together using a mortar to prepare a mixture.

Table 1 presents the evaluation results. SEM observation of the resulting powder revealed that the resulting powder were plate-like particles having a polygonal plate shape, containing very few aggregates, and having excellent handleability. XRD measurement revealed that a sharp scattering peak originating from α-alumina appeared, a peak originating from alumina crystals other than the α-crystal structure was not observed, the degree of a crystallization was 99% or more (almost 100%), and the plate-like alumina had a dense crystal structure. The results of the quantitative X-ray fluorescence analysis revealed that the resulting particles contained 0.42% by mass molybdenum in terms of molybdenum trioxide. The solid-state ²⁷Al NMR analysis at a static magnetic field strength of 14.1 T and the solid-state ²⁷Al NMR analysis at a static magnetic field strength of 21.1 T revealed that the peak of six-coordinated aluminum was detected in each analysis. The longitudinal relaxation time T₁ for six-coordinated aluminum at a static magnetic field strength of 14.1 T was 11.1 seconds. As with Example 6, the results indicated that even in the case where the shape-controlling agent was changed to the Ge compound, good values were obtained.

### Comparative Example 1

First, 50 g of aluminum hydroxide (available from Nippon Light Metal Co., Ltd., average particle size: 12 μm), 0.65 g of silicon dioxide (Kanto Chemical Co., Inc.), and 1.72 g of molybdenum trioxide (available from Taiyo Koko Co., Ltd.) were mixed together using a mortar to prepare a mixture. The resulting mixture was placed in a crucible and fired by heating the mixture to 950° C. at 5° C./min with a ceramic electric furnace and holding the mixture at 950° C. for 10 hours. Subsequently, the mixture was cooled to room temperature at 5° C./min. The crucible was then taken out to give 34.2 g of a light blue powder. The resulting powder was disintegrated with a mortar until it passed through a sieve with 106-μm openings.

Then the resulting powder was dispersed in 150 mL of a 0.5% aqueous ammonia solution. The dispersion was stirred at room temperature (25° C. to 30° C.) for 0.5 hours and filtered to remove the aqueous ammonia solution. The resulting particles were washed with water and dried to remove molybdenum left on the surfaces of the particles to give 33.4 g a light blue powder.

Table 1 presents the evaluation results. SEM observation of the resulting powder revealed that the resulting powder were plate-like particles having a polygonal plate shape, containing very few aggregates, and having excellent handleability. XRD measurement revealed that a sharp scattering peak originating from α-alumina appeared, a peak originating from alumina crystals other than the α-crystal structure was not observed, the degree of α crystallization was 99% or more (almost 100%), and the plate-like alumina had a dense crystal structure. The results of the quantitative X-ray fluorescence analysis revealed that the resulting particles contained 0.84% by mass molybdenum in terms of molybdenum trioxide. The solid-state ²⁷Al NMR analysis at a static magnetic field strength of 14.1 T and the solid-state ²⁷Al NMR analysis at a static magnetic field strength of 21.1 T revealed that the peak of six-coordinated aluminum was detected in each analysis. The longitudinal relaxation time T₁ for six-coordinated aluminum at a static magnetic field strength of 14.1 T was 4.8 seconds. The results indicated that: since the firing temperature was lower than those in Examples 1 to 7, the value of the longitudinal relaxation time T₁ was small, and the plate-like alumina particles had inferior crystallinity.

### Comparative Example 2

Evaluations were performed with commercially available plate-like alumina (Serath, available from Kinsei Matec Co., Ltd., average particle size: 7.7 μm).

Table 1 presents the evaluation results. The solid-state ²⁷Al NMR analysis at a static magnetic field strength of 14.1 T and the solid-state ²⁷Al NMR analysis at a static magnetic field strength of 21.1 T revealed that the peak of six-coordinated aluminum was detected in each analysis. The longitudinal relaxation time T₁ for six-coordinated aluminum at a static magnetic field strength of 14.1 T was 4.5 seconds, which was lower than those in Examples 1 to 7.

### Comparative Example 3

Evaluations were performed with commercially available plate-like alumina (Serath, available from Kinsei. Matec Co., Ltd., average particle size: 5.3 μm).

Table 1 presents the evaluation results. The solid-state ²⁷Al NMR analysis at a static magnetic field strength of 14.1 T and the solid-state ²⁷Al NMR analysis at a static magnetic field strength of 21.1 T revealed that the peak of six-coordinated aluminum was detected in each analysis. The longitudinal relaxation time T: for six-coordinated aluminum at a static magnetic field strength of 1.4.1 T was 3.2 seconds, which was lower than those in Examples 1 to 7.

### Comparative Example 4

Evaluations were performed with commercially available alumina particles (available from Nippon Light Metal Co., Ltd).

Table 1 presents the evaluation results. The average particle size was measured and found to be 6.5 μm. The thickness was measured and found to be 1.5 μm. Thus, the aspect ratio was 4.3. The aspect ratio was lower than those in Examples 1 to 7. The solid-state ²⁷Al NMR analysis at a static magnetic field strength of 14.1 T and the solid-state ²⁷Al NMR analysis at a static magnetic field strength of 21.1 T revealed that in addition to the peak of six-coordinated aluminum, a clear peak of four-coordinated aluminum was also detected in each analysis. The longitudinal relaxation time T₁ for six-coordinated aluminum at a static magnetic field strength of 14.1 T was 11.3 seconds.

Table 1 presents the evaluation results and the formulation of the raw-material compounds on an oxide basis (100% by mass in total).

TABLE 1

| | | | | | | | | | | Compara- | Compara- | Compara- | Compara- |
|---|---|---|---|---|---|---|---|---|---|---|---|---|---|
| | | | | | | | | | | tive | tive | tive | tive |
| | | Oxide | Exam- | Exam- | Exam- | Exam- | Exam- | Exam- | Exam- | example | example | example | example |
| | | basis | ple 1 | ple 2 | ple 3 | ple 4 | ple 5 | ple 6 | ple 7 | 1 | 2 | 3 | 4 |
| Formula- | Aluminum | Al₂O₃ | 93.2 | 93.2 | 94.1 | 92.4 | 81.0 | 93.7 | 90.7 | 93.2 | — | — | — |
| tion | compound | | | | | | | | | | | | |
| | Molybdenum | MoO₃ | 4.9 | 4.9 | 5.0 | 4.9 | 18.2 | 4.9 | 4.8 | 4.9 | — | — | — |
| | compound | | | | | | | | | | | | |
| | Shape- | SiO₂ | 1.9 | 1.9 | 0.9 | 2.8 | 0.8 | 0.0 | 0.0 | 1.9 | — | — | — |
| | controlling | GeO₂ | 0.0 | 0.0 | 0.0 | 0.0 | 0.0 | 1.4 | 4.5 | 0.0 | — | — | — |
| | agent | | | | | | | | | | | | |

| | | | | | | | | | | | |
|---|---|---|---|---|---|---|---|---|---|---|---|
| Firing temperature (° C.) | 1200 | 1300 | 1400 | 1200 | 1200 | 1200 | 1200 | 950 | — | — | — |
| Average particle size L (μm) | 7.2 | 6.8 | 6.2 | 3.9 | 7.2 | 13.1 | 12.6 | 8.5 | 7.7 | 5.3 | 6.5 |
| Thickness T (μm) | 0.45 | 0.45 | 0.5 | 0.2 | 0.5 | 0.7 | 0.5 | 0.45 | 0.5 | 0.4 | 1.5 |
| Aspect ratio L/T | 16.0 | 15.1 | 12.4 | 19.5 | 14.4 | 18.7 | 25.2 | 18.9 | 15.4 | 13.3 | 4.3 |
| Longitudinal relaxation time of | 7.5 | 9.5 | 9.0 | 6.5 | 8.3 | 10.1 | 11.1 | 4.8 | 4.5 | 3.2 | 11.3 |
| 6-coordination T₁ (s) | | | | | | | | | | | |
| Detection of 4-coordination | not de- | not de- | not de- | not de- | not de- | not de- | not de- | not de- | not de- | not de- | de- |
| | tected | tected | tected | tected | tected | tected | tected | tected | tected | tected | tected |
| XRF MoO₃ (% by mass) | 0.32 | 0.77 | 0.68 | 0.85 | 1.16 | 1.28 | 0.42 | 0.84 | not de- | not de- | not de- |
| | | | | | | | | | tected | tected | tected |
| Processing stability | ∘ | ∘ | ∘ | ∘ | ∘ | ∘ | ∘ | x | x | x | x |
| Shape retention rate (%) | 97 | 98 | 98 | 98 | 97 | 98 | 96 | 86 | 83 | 81 | 88 |

From the above results, the following can be concluded.

The plate-like alumina particles exhibiting a longitudinal relaxation time T₁ of 5 seconds or more according to Examples 1 to 7 probably had high hardness due to their high crystallinity, compared with the plate-like alumina particles exhibiting a longitudinal relaxation time T₁ of less than 5 seconds according to Comparative examples 1 to 3; thus, the particles were not easily broken through the melt-kneading and were excellent in shape retention rate.

The plate-like alumina particles according to Comparative example 4 exhibited a longitudinal relaxation time T₁ of 5 seconds or more but had an aspect ratio of less than 5. In the plate-like alumina particles according to Comparative example 4, the peak of the four-coordination was detected. This also presumably indicates that the particles are susceptible to breakage and detachment caused by the distortion of the intended property of the crystals probably due to the fact that the crystal structure contains crystals with a different coordination number from those of the plate-like alumina particles according to Examples 1 to 7. The plate-like alumina particles according to Examples 1 to 7 had superior shape retention rates.

The plate-like alumina particles having high shape retention rates according to Examples 1 to 7 were significantly useful because when a resin composition containing the plate-like alumina particles according to each of Examples 1 to 7 was prepared, the resin composition had excellent processing stability, compared with the plate-like alumina particles having low shape retention rates according to Comparative examples 1 to 4.

Configurations and combinations thereof in the embodiments are merely examples, and addition, omission, replacement, and other modifications of the configurations can be made without departing from the scope of the present invention. In addition, the present invention is not limited to the embodiments and is limited by only the claims.

1. Plate-like alumina particles characterized by having an aspect ratio of 5 to 500,
wherein in solid-state ²⁷Al NMR analysis, a longitudinal relaxation time T₁ for a peak of six-coordinated aluminum at 10 to 30 ppm is 5 seconds or more at a static magnetic field strength of 14.1 T.

2. The plate-like alumina particles according to claim 1, further comprising silicon and/or germanium.

3. The plate-like alumina particles according to claim 1, further comprising molybdenum.

4. The plate-like alumina particles according to claim 3, wherein the plate-like alumina particles have a molybdenum content of 0.1% or more and 1% or less by mass in terms of molybdenum trioxide based on 100% by mass of the total mass of the plate-like alumina particles.

5. The plate-like alumina particles according to claim 1, wherein the plate-like alumina particles have a thickness of 0.01 to 5 μm and an average particle size of 0.1 to 500 μm.

6. The plate-like alumina particles according to claim 1, wherein the plate-like alumina particles have an average particle size of 0.1 to 7 μm.

7. A method for producing plate-like alumina particles according to claim 1, comprising mixing an aluminum element-containing aluminum compound, a molybdenum element-containing molybdenum compound, and a shape-controlling agent together to prepare a mixture, and firing the mixture at 1,200° C. or higher.

8. The method for producing plate-like alumina particles according to claim 7, wherein the shape-controlling agent is at least one selected from the group consisting of silicon, silicon compounds, and germanium compounds.

9. The method for producing plate-like alumina particles according to claim 8, wherein 50% or more by mass of the aluminum element-containing aluminum compound in terms of Al₂O₃, 2% or more by mass and 15% or less by mass of the molybdenum element-containing molybdenum compound in terms of MoO₃, and 0.1% or more by mass and 10% or less by mass of the shape-controlling agent in terms of SiO₂ or GeO₂ based on 100% by mass of the total amount of the raw materials on an oxide basis are mixed together to prepare a mixture, and the mixture is fired.

10. A resin composition, comprising a resin and the plate-like alumina particles according to claim 1.

11. The plate-like alumina particles according to claim 1, further comprising silicon and/or germanium; and molybdenum.

12. The plate-like alumina particles according to claim 11, wherein the plate-like alumina particles have a molybdenum content of 0.1% or more and 1% or less by mass in terms of molybdenum trioxide based on 100% by mass of the total mass of the plate-like alumina particles.

13. The plate-like alumina particles according to claim 1, wherein the plate-like alumina particles have a thickness of 0.01 to 5 μm and an average particle size of 0.1 to 500 μm, and the plate-like alumina particles have an average particle size of 0.1 to 7 μm.
